(19) United States
(12) Patent Application Publication
(10) Pub. No.: US 2013/0169900 A1
(43) Pub. Date: Jul. 4, 2013

(54) Non-Optically Bonded Display Device

(71) Applicant: Rajesh Manohar Dighde, Redmond, WA (US)

(72) Inventor: Rajesh Manohar Dighde, Redmond, WA (US)

(73) Assignee: Microsoft Corporation, Redmond, WA (US)

(21) Appl. No.: 13/342,180

(22) Filed: Jan. 2, 2012

(51) Int. Cl. G02F 1/13357; G02F 1/1368; F21V 8/00; G02B 5/00; G02B 1/11

(52) U.S. Cl. 349/43; 359/893; 359/601; 362/602

(57) ABSTRACT

Various embodiments provide a display that utilizes a film having a plurality of compliant microdots to non-optically bond a layer of chemically strengthened protective glass to the display. The film, microdots, and chemically strengthened protective glass provide an assembly provides a non-bonded ruggedized, interactive display that is highly functional, safe, and easy to construct.

### BACKGROUND

Flat screen displays have become both thinner and available in larger screen sizes in recent years. Some of these flat screen displays also include touch and multi-touch sensing capabilities. These thinner, wider, and touch-sensitive displays have been employed in various operating environments, such as horizontally oriented multi-touch tabletop displays, or inclined kiosk displays, etc., in which the displays experience forces on their display surface during use. Unfortunately, conventional flat screen displays can be easily damaged by such forces resulting in high replacement costs and frustrating downtime during repair. Additionally, forces on such thin displays may cause deflection that results in display artifacts such as, liquid crystal banding, flashing, pooling, or an uneven surface on the display, resulting in an unsatisfactory user experience.

The traditional approach in constructing these and other types of displays has been to utilize a chemically-hardened, high-strength optically clear glass that is bonded, as by optically bonding the glass to the display. In some designs, the cover glass is an integral part of the touch sensor. Optically-bonding the high-strength glass carries with it several disadvantages among which include a high construction cost and the risk of a complete display compromise in the event that the high-strength glass breaks, resulting in replacement costs for the entire cover glass and LCD. Moreover, bonding thicker panels carries with it significant challenges insofar as reducing parallax. Furthermore, for displays that utilize embedded vision sensors such as sensor-in-pixel sensors, the high-strength cover glass is typically very thin and the bonding layer needs to be applied in an extremely uniform manner to provide consistent performance across the surface of the display.

Assembly of such displays can pose significant challenges because of design tolerances, handling, and shipping considerations, to name just a few.

### SUMMARY

This Summary introduces simplified concepts of a non-optically bonded display device, and the concepts are further described below in the Detailed Description and/or shown in the Figures. This Summary should not be considered to describe essential features of the claimed subject matter, nor used to determine or limit the scope of the claimed subject matter.

Various embodiments provide a display that utilizes a film having a plurality of compliant microdots to non-optically bond a layer of chemically strengthened protective glass to the display. The film, microdots, and chemically strengthened protective glass provide an assembly that provides a non-bonded ruggedized, interactive display that is highly functional, safe, and easy to construct.

### BRIEF DESCRIPTION OF THE DRAWINGS

FIG. 1 illustrates a computing device including a non-optically bonded display in accordance with one or more embodiments.

FIG. 2 illustrates a computing device including a non-optically bonded display in accordance with one or more embodiments.

FIG. 3 illustrates an assembly comprising a film having a plurality of microdots formed thereon in accordance with one or more embodiments.

FIG. 4 illustrates the FIG. 3 assembly mounted on an example chemically strengthened protective glass layer, in accordance with one or more embodiments.

FIG. 5 illustrates the FIG. 4 assembly in a positional assembly relationship relative to an example display stack up, in accordance with one or more embodiments.

FIG. 6 illustrates an assembled display stack up including the FIG. 4 assembly, in accordance with one or more embodiments.

FIG. 7 illustrates an example display that utilizes the FIG. 6 assembled display stack up in accordance with one or more embodiments.

FIG. 8 is a flow diagram that describes steps in a method in accordance with one or more embodiments.

FIG. 9 illustrates various components of an example device in which various embodiments can be implemented.

### DETAILED DESCRIPTION

### Overview

Various embodiments provide a display that utilizes a film having a plurality of compliant microdots to non-optically bond a layer of chemically strengthened protective glass to the display. The film, microdots, and chemically strengthened protective glass provide an assembly that provides a non-bonded ruggedized, interactive display that is highly functional, safe, and easy to construct.

By eliminating the need to optically bond the assembly to an associated display stack up, modularity is provided which, in turn, makes the assembly process very straightforward and simple.

Consider now some example operating environments in which the inventive displays can be utilized.

Example Operating Environments

While features and concepts of a non-optically bonded display can be implemented in any number of different devices, systems, and/or configurations, embodiments of a non-optically bonded display are described in the context of the following example devices, systems, and methods.

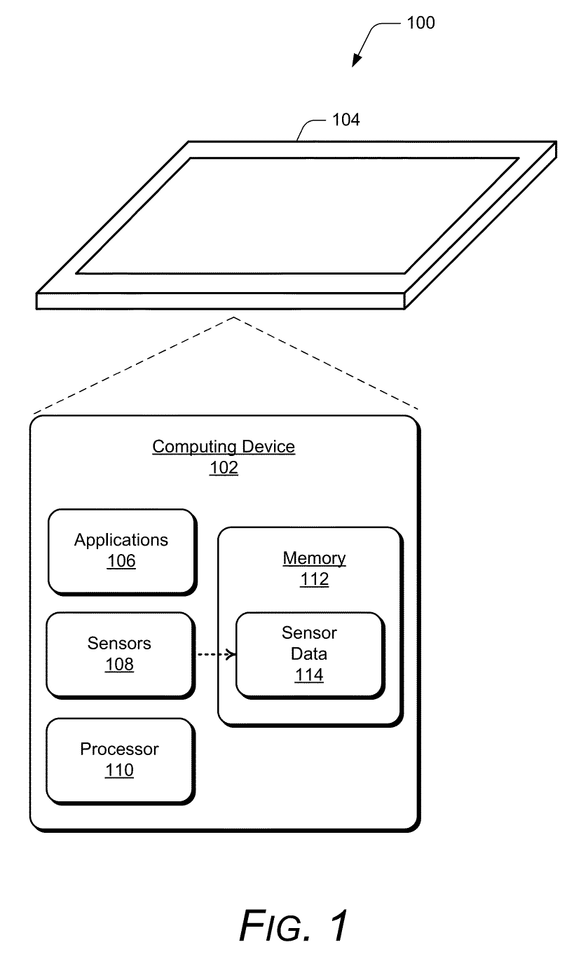

FIG. 1 illustrates an example system 100 in accordance with one or more embodiments. The example system 100 includes a computing device 102 and a non-optically bonded display 104. In the illustrated and described example, display 104 comprises a touch-sensitive display having a larger form factor such as, by way of example and not limitation, a tabletop display. It is to be appreciated and understood, however, that smaller form factor devices can employ the embodiments described herein including, by way of example and not limitation, tablet, slate, and handheld devices such as cell phones and the like. Display 104 includes, as part of its internal stack up and as described below, a film comprising a plurality of compliant microdots enabling the display to be constructed to be non-optically bonded. By employing the film having the compliant microdots, a construction is provided that dissipates impact energy by distributing the impact energy under the entire display panel area and, at the same time, reduces localized deflection of the display panel that can lead to panel failure. Additionally, this film with compliant microdots can be an integral part of the touch sensor stack, e.g. protection film. Supply chain logistics are facilitated because subassemblies within the stack up can be assembled at any stage. The assembly process, in turn, is very simple and does not utilize precision alignment bonding fixtures. Moreover, in the event that re-work is desired, such is facilitated through the use of the film having compliant microdots. Replacement costs in case of breakage are lower as the cover glass (with and without the embedded touch sensor) can be easily replaced thus saving an expensive display.

In the illustrated and described embodiment, the computing device 102 can be implemented with various components, including one or more applications 106, one or more sensors 108 to facilitate touch-sensing, one or more processors 110, and one or more computer-readable storage media such as memory 112. Memory 112 can include sensor data 114, provided by sensors 108, that is processed to provide user input to the display 104.

Processor(s) 110 can include any of microprocessors, controllers, and the like. Memory 112 (e.g., a computer-readable storage media device) enables data storage on the computing device 102. The processor and memory of the computing device can implement various types of functionality by way of computer-executable instructions, such as a software application(s) 106.

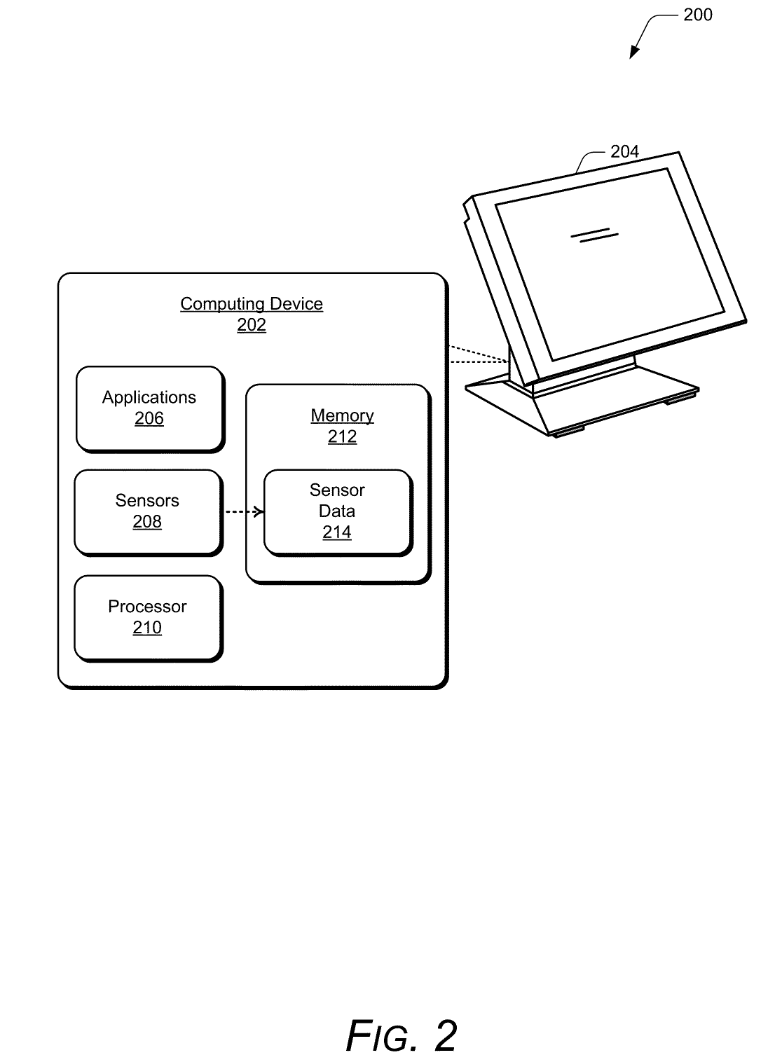

FIG. 2 illustrates another example system 200 in accordance with one or more embodiments. The example system 200 includes a computing device 202 and a non-optically bonded display 204. In the illustrated and described example, display 204 comprises a touch-sensitive, inclined or tilt-able display having a form factor such as, by way of example and not limitation, a display that might be employed in a kiosk or some other type of computing device. Display 204 includes, as part of its internal stack up and as described below, a film comprising a plurality of compliant microdots enabling the display to be constructed to be non-optically bonded.

In the illustrated and described embodiment, the computing device 202 can be implemented with various components, including one or more applications 206, one or more sensors 208 to facilitate touch-sensing, one or more processors 210, and one or more computer-readable storage media such as memory 212. Memory 212 can include sensor data 214, provided by sensors 208, that is processed to provide user input to the display 204.

Processor(s) 210 can include any of microprocessors, controllers, and the like. Memory 212 (e.g., a computer-readable storage media device) enables data storage on the computing device 202. The processor and memory of the computing device can implement various types of functionality by way of computer-executable instructions, such as a software application(s) 206.

Having considered various operating environments in accordance with one or more embodiments, consider now a discussion of a film employing a plurality of microdots in accordance with one or more embodiments.

Example Film with Microdots

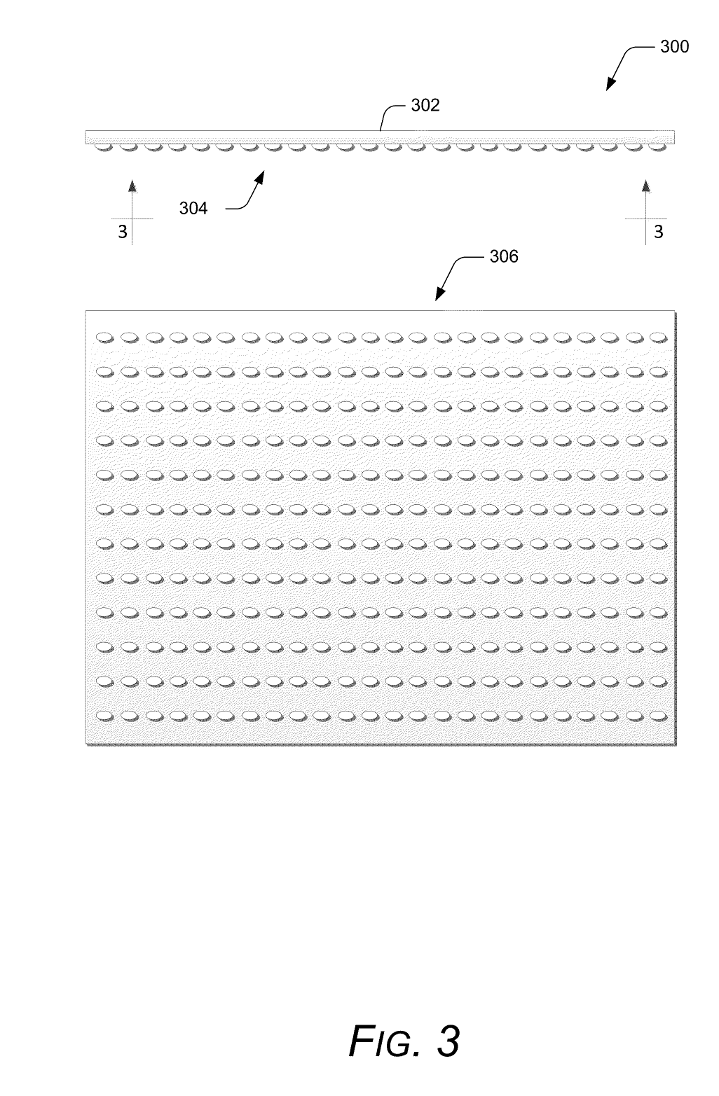

FIG. 3 illustrates an example assembly, generally at 300, in accordance with one or more embodiments. In this particular example, assembly 300 includes a film 302 having a plurality of microdots 304 formed thereon. Film 302 can comprise any type of film suitable for use in displays as described herein. In at least some embodiments, film 302 comprises an optically clear, compliant, antireflective film. Microdots 304 can be formed from any suitable type of material. Such materials can include, by way of example and not limitation, optically clear material that shares the same reflective index as a protective glass layer that is mounted adjacent assembly 300, as described below. In at least some embodiments, material that is utilized to form the microdots comprises a transparent thermoplastic material such as, by way of example and not limitation, poly methyl methacrylate (PMMA). Other materials such as PET, PC or other optically clear material can be utilized. The microdots can be formed on film 302 in any suitable way. For example, the microdots can be formed through a printing process, such as through an ink jet printing process. Alternately, the microdots can be formed on film 302 during an extrusion process when the film is formed. Specifically, features on extrusion rollers which are used to extrude film 302 can apply the microdots during extrusion.

The microdots can have any suitable shape and dimension, depending on the particular display application in which they are used. For example, the illustrated microdots have a generally semi-spherical shape. Other shapes can include, by way of example and not limitation, rectangular shapes, oval shapes, and other geometric shapes. In at least some embodiments, the microdots can have a height from between about 0.1 mm to 0.4 mm. In addition, the microdots can be laid out on film 302 in any suitable arrangement.

As but one example, consider the top plan view of film 302, taken along line 3-3, and designated generally at 306. There, the microdots are arranged to have uniform spacing therebetween, and are arranged in a generally rectangular pattern in rows and columns. Other arrangements can, of course, be used. For example, other geometric arrangements of microdots can include, by way of example and not limitation, circular arrangements, such as concentric circles, and the like. In addition, spacing as between the individual microdots can vary, and need not necessarily be uniform across the film 302. The illustrated and described film/microdots can be utilized in connection with any suitably-dimensioned display. For example, the film/microdots can be used in connection with any displays ranging in size from 3″ to 82″ in diagonal, as well as others. It can be particularly useful for the larger devices given the increased difficulty of bonding larger displays, controlling uniformity of bond thickness, achieving cosmetic quality, etc.

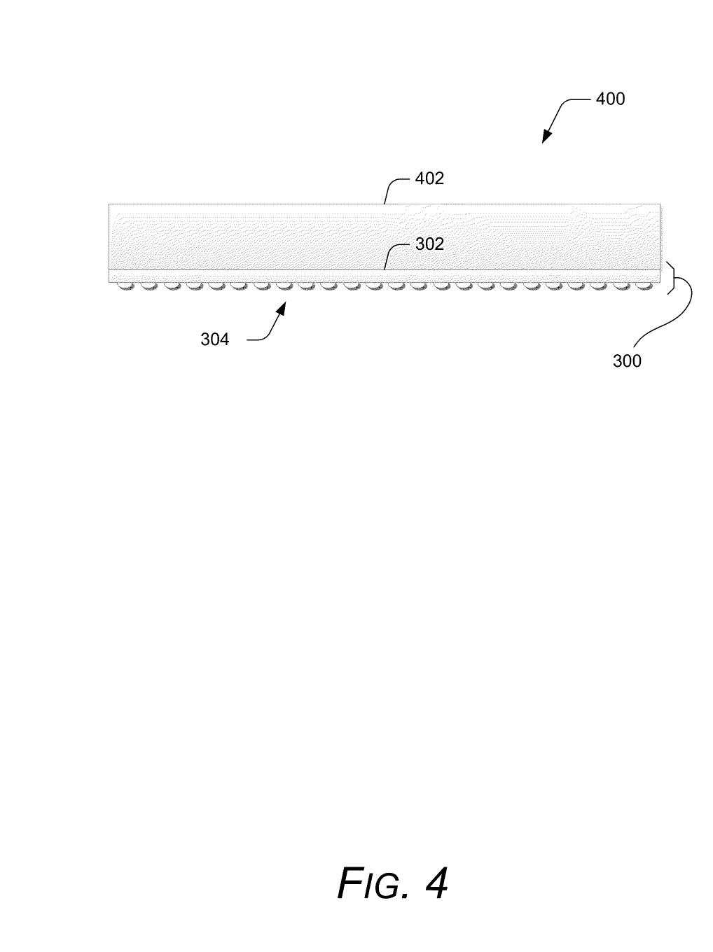

FIG. 4 illustrates an assembly 400 in accordance with one or more embodiments. Assembly 400 includes assembly 300 including film 302 and microdots 304. In addition, assembly 400 includes a layer of chemically strengthened protective glass 402. Various compositions are possible, such as soda lime glass, alumino silicate glass, lithium silicate glass, and the like. The protective glass can be any suitable thickness depending on the display application. In the illustrated and described embodiment, protective glass 402 has a thickness from between about 0.2 mm to 1.1 mm. The dimensions of protective glass 402 are such that the protective glass is impact resistant and, at the same time, reduce parallax. Assembly 300 can be affixed to protective glass 402 in any suitable way such as, by way of example and not limitation, vacuum lamination, roller lamination, etc). In at least some embodiments, film 302 is laminated to the surface of protective glass 402.

The assembly 400, when formed, constitutes a sub-assembly that can be easily incorporated into a display to provide a non-optically bonded solution. That is, in at least some embodiments, assembly 400 can simply be “dropped into” a display stack up as will become apparent below. By eliminating the need to optically bond assembly 400 to the display stack up, modularity is provided which, in turn, makes the assembly process very straightforward and simple, thus reducing cost. Further, the process that incorporates assembly 400 in a display's stack up does not utilize precise alignment bonding fixtures, as in optically-bonded approaches, thus making the assembly process faster and more efficient.

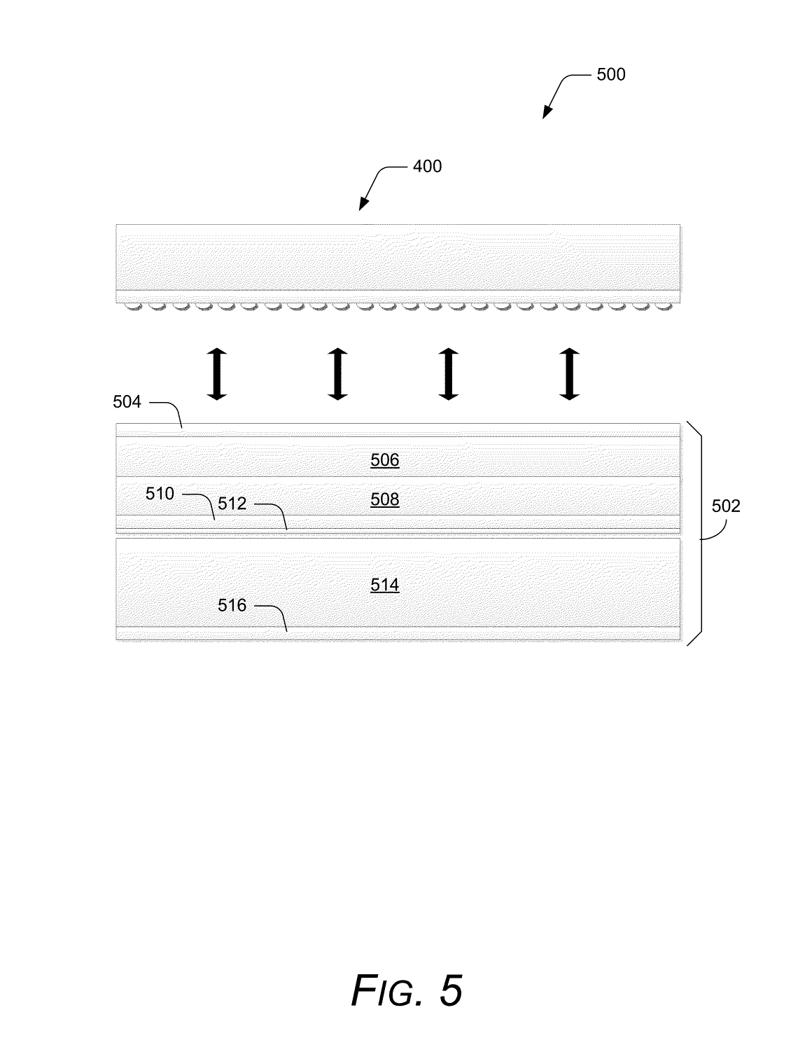

FIG. 5 illustrates an assembly 500 accordance with one or more embodiments. In this example, assembly 500 includes assembly 400 (FIG. 4) and a display stack up, shown generally at 502. Assembly 400 can be utilized with any suitably-configured display stack up 502 having any number of components or layers using any suitable type of technology. Accordingly, the illustrated stack up is not intended to limit application of the claimed subject matter to the specific stack up shown.

In this particular example, stack up 502 includes an LCD panel comprising a polarizer 504, a liquid crystal display color filter (LCD CF) 506, a liquid crystal display thin-film transistor array (LCD TFT) 508, and a polarizer 510. In the illustrated and described embodiment, LCD CF 506 has a thickness from between about 0.3 mm to 0.7 mm. LCD TFT 508 has a thickness from between about 0.3 mm to 0.7 mm. Alternately, the stack up 502 can include one or more organic light emitting diode (OLED) displays comprised of a plurality of light emitting pixels. In one or more embodiments, the panel is configured to enable touch sensitivity or multi-touch sensitivity. Various touch sensitive technologies may be employed. For example, the panel may include optical sensors, which may be positioned in multiple pixels or each pixel to sense light, and output from these optical sensors may be processed to detect multiple touches on the top surface of an associated display. These optical sensors may be configured to sense visible light and infrared light. For instance, the optical sensors may be an active pixel sensor (APS), such as complementary metal-oxide semiconductor (CMOS) or any other APS configured to sense visible light and/or infrared light. As an alternative to in-pixel optical sensors, a capacitive layer may be provided and configured to detect touch on the top surface of the display through changes in detected capacitance caused by the touch.

In addition, stack up 502 includes a compliant optical sheet 512, a controlled air gap between the compliant optical sheet 512 and a light guide plate 514, and a compliant support layer 516. Collectively, stack up 502 provides a ruggedized, impact-dissipating construction. The compliant optical sheet 512 and compliant support layer 516 are formed from materials that dissipate impact energy. Suitable materials include, by way of example and not limitation, urethanes, silicones, PMMA and other materials that can be optically index matched to the film to avoid the aberations.

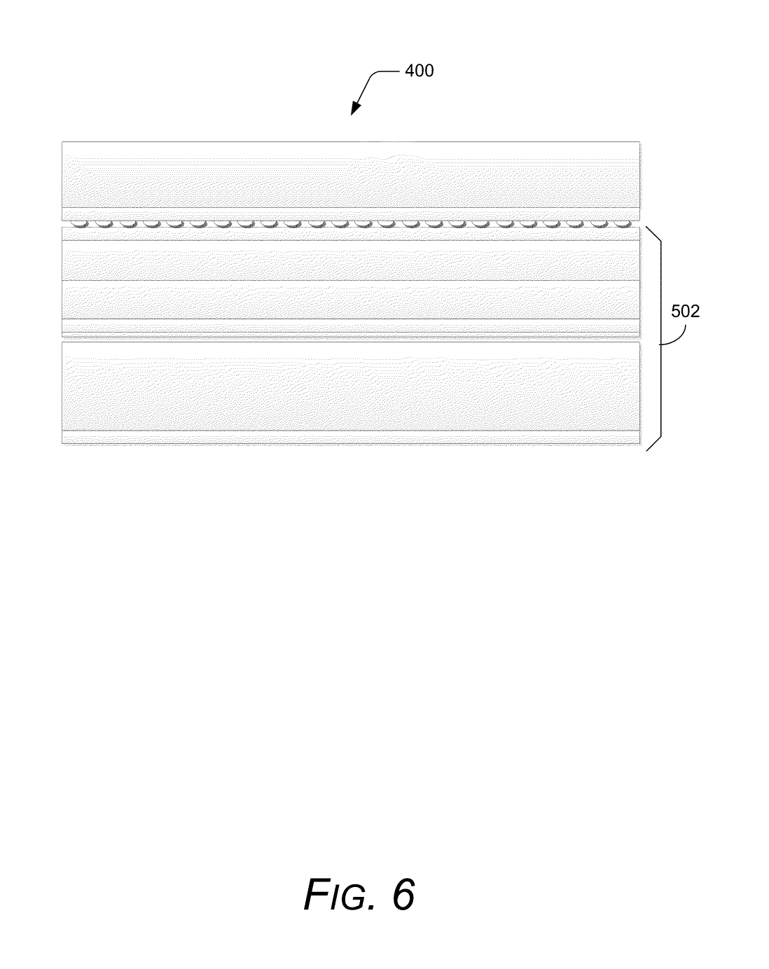

In operation, assembly 400 can be mounted on stack up 502 in any suitable way. For example, housing structure can surround assembly 400 and stack up 502 to provide mechanical support for the entire assembly 500. When assembly 400 is mounted on stack up 502, the microdots provide a spacer function that provides the functionality of a bonded display, without utilizing optical bonding between assembly 400 and the stack up 502. As an example, consider FIG. 6.

There, assembly 400 is shown mounted on stack up 502. The microdots can be seen to provide uniform spacing between the assembly 400 and the underlying stack up 502. This, in turn, provides uniformity across the surface of the protective glass forming part of assembly 400.

Having considered example assemblies that can be used to form a display, consider now a specific implementation in which the assemblies are utilized in a ruggedized, impact-resistant display.

Example Implementation

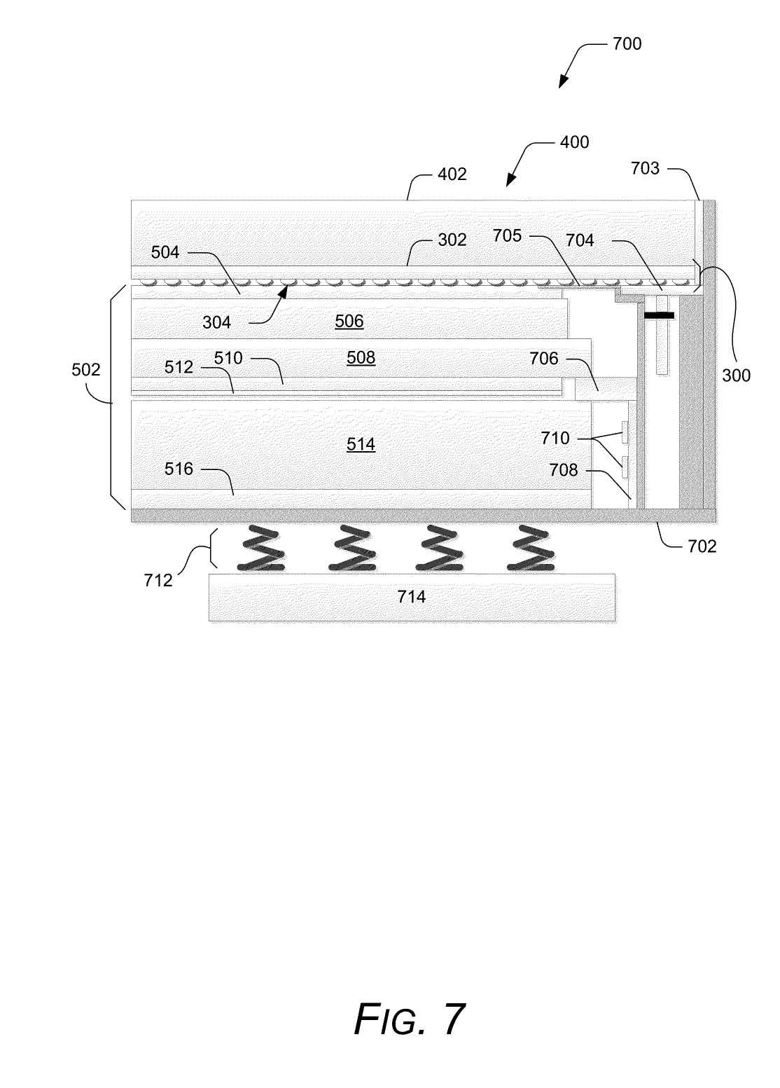

FIG. 7 illustrates an example display, in accordance with one or more embodiments, generally at 700. Like numerals from the above-described embodiments have been utilized to depict like components. Accordingly, display 700 includes a housing 702 configured to house the various assemblies described above, in an operative arrangement, to provide a ruggedized, impact-resistant display.

Display 700 includes assembly 400 which, in turn, is formed to include an assembly 300 comprising film 302 and microdots 304. In addition, assembly 400 includes a layer of chemically strengthened protective glass 402, such as that described above. Assembly 400 is mounted to housing 702 by way of a compliant gasket 703 interposed between the assembly and the housing. The compliant gasket 703 not only provides a mechanical mount to the housing 702, but also serves as a dust protector to prevent dust from entering the interior of the housing.

In addition, an adjustable adapter plate 704 is provided and is interposed between assembly 400 and housing 702 to provide both co-planarity and a solid surface in a glass overhang region. Furthermore, the adjustable adapter plate 704 serves to provide side impact protection.

As noted above, the assembly 400 constitutes a sub-assembly that can be easily incorporated into a display to provide a non-optically bonded solution. That is, in at least some embodiments, assembly 400 can simply be “dropped into” a display stack up as shown here. By eliminating the need to optically bond assembly 400 to the display stack up, modularity is provided which, in turn, makes the assembly process very straightforward and simple.

Display 700 further includes a display stack up shown generally at 502. Assembly 400 can be utilized with any suitably-configured display stack up 502. Accordingly, the illustrated stack up is not intended to limit application of the claimed subject matter to the specific stack up shown.

In this particular example, stack up 502 includes an LCD panel comprising a polarizer 504, a liquid crystal display color filter (LCD CF) 506, a liquid crystal display thin-film transistor array (LCD TFT) 508, and a polarizer 510. In the illustrated and described embodiment, LCD CF 506 has a thickness from between about 0.3 mm to 0.7 mm. LCD TFT 508 has a thickness from between about 0.3 mm to 0.7 mm. Other smaller dimensions are possible without departing from the spirit and scope of the claimed subject matter.

In addition, stack up 502 includes a compliant optical sheet 512, a controlled air gap between the compliant optical sheet 512 and a light guide plate 514, and a compliant support layer 516. Collectively, stack up 502 provides a ruggedized, impact-dissipating construction. The compliant optical sheet 512 and compliant support layer 516 are formed from materials that dissipate impact energy.

In addition, display 700 includes a gasket 705 interposed between, on one side, structure of the housing 702 and polarizer 504, and microdots 304. The gasket 705 serves as a seal to prevent dust from entering the interior of the housing. A flexible mount 706 is interposed between LCD TFT 506 and light guide plate 514 to provide mechanical support in the gap shown. A printed circuit board (PCB) layer supports electronics that power a light source that includes, in this example, an array of edge-lit LEDs, two of which are shown at 710. A spring assembly 712 provides impact resistance between the display 700 and an external support mechanism 714.

Various embodiments, such as the one described just above, provide a display with a film 302 having a plurality of compliant microdots 304 to non-optically bond a layer of chemically strengthened protective glass 402 to the display. The film, microdots, and chemically strengthened protective glass provide an assembly that provides a non-bonded, ruggedized, interactive display that is highly functional, safe, and easy to construct.

By eliminating the need to optically bond assembly 400 to an associated display stack up, such as stack up 502, modularity is provided which, in turn, makes the assembly process very straightforward and simple.

Having considered an example display that employs the described non-optically bonded solution, consider now an example method in accordance with one or more embodiments.

Example Method

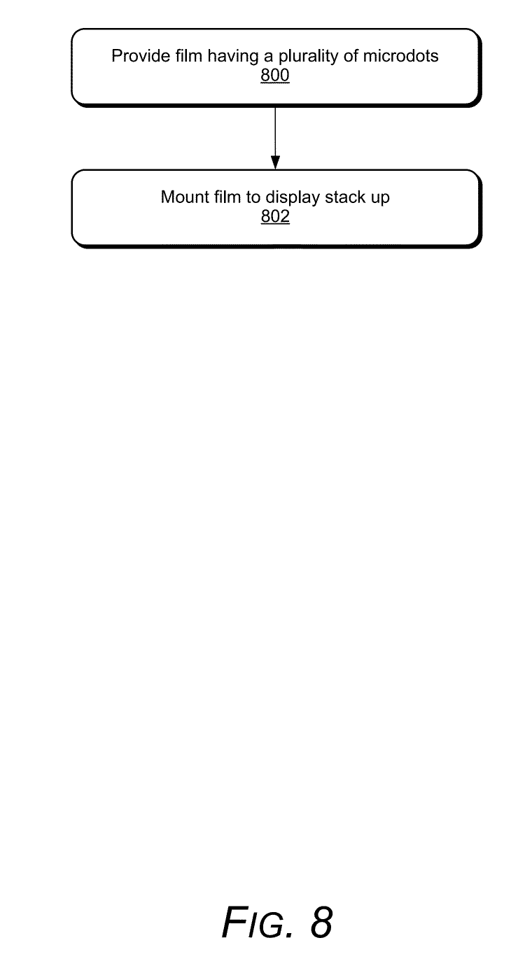

FIG. 8 is a flow diagram that describes steps in an assembly method accordance with one or more embodiments. The assembly method provides a ruggedized, impact resistant display.

Step 800 provides a film having a plurality of microdots. Any suitable film can be utilized examples of which are provided above. In addition, any geometric arrangement, number, and construction of microdots can be utilized.

Step 802 mounts the film, including the microdots, to a display stack up. The use of the film and microdots provides a non-optically bonded solution for various types of displays, examples of which are provided above.

Having described an example method in accordance with one or more embodiments, consider now an example computing device that can utilize the displays as described above.

Example Computing Device

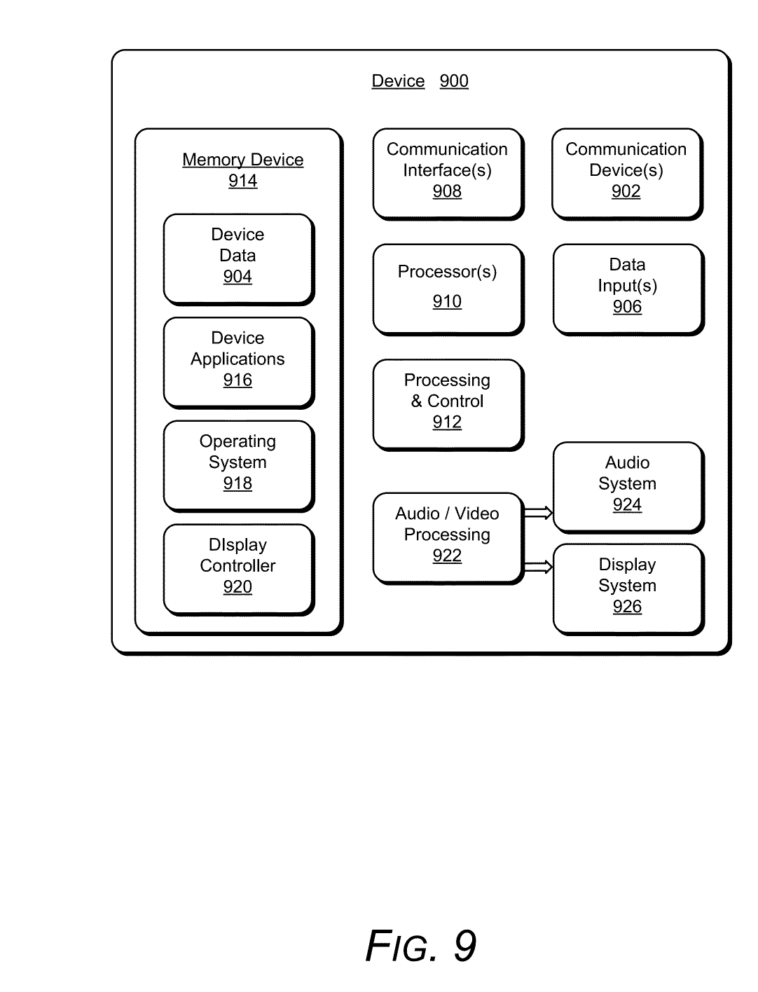

FIG. 9 illustrates various components of an example device 900 that can be implemented as any of the devices described with reference to the previous FIGS. 1 and 2. In embodiments, the device may be implemented as any one or combination of a computing device, all-in-one computer, consumer, user, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 900 includes communication devices 902 that enable wired and/or wireless communication of device data 904, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 906 via which any type of data, media content, and/or inputs can be received, such as user-selectable inputs and any other type of audio, video, and/or image data received from any content and/or data source.

The device 900 also includes communication interfaces 908, such as any one or more of a serial, parallel, network, or wireless interface. The communication interfaces provide a connection and/or communication links between the device and a communication network by which other electronic, computing, and communication devices communicate data with the device. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 900 includes one or more processors 910 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 912. The device 900 also includes one or more memory devices 914 (e.g., computer-readable storage media devices) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store data and which can be accessed by a computer.

Communication media typically embody computer-readable instructions, data structures, program modules, or other data in a modulated data signal, such as carrier wave or other transport mechanism. Communication media also include any information delivery media. A modulated data signal has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 914 provides data storage mechanisms to store the device data 904, other types of information and/or data, and various device applications 916. For example, an operating system 918 can be maintained as a software application with the memory device and executed on the processors. The device applications may also include a device manager, such as any form of a control application, software application, signal processing and control module, code that is native to a particular device, a hardware abstraction layer for a particular device, and so on. In this example, the device applications 916 include a display controller 920 that can implement processing of touch-related inputs.

The device 900 also includes an audio and/or video processing system 922 that generates audio data for an audio system 924 and/or generates display data for a display system 926. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device. The display system 926 can include one or more displays that are configured and constructed as described above.

### CONCLUSION

Various embodiments provide a display that utilizes a film having a plurality of compliant microdots to non-optically bond a layer of chemically strengthened protective glass to the display. The film, microdots, and chemically strengthened protective glass provide an assembly provides a non-bonded ruggedized, interactive display that is highly functional, safe, and easy to construct.

By eliminating the need to optically bond the assembly to an associated display stack up, modularity is provided which, in turn, makes the assembly process very straightforward and simple.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

1. An assembly comprising:
a compliant optically clear film; and
a plurality of microdots formed on film;
the assembly being dimensioned to be utilized in a display between a layer of protective glass and a display stack up in which the film and plurality of microdots are configured to be non-optically bonded to the stack up.

2. The assembly of claim 1, wherein the film comprises a clear, antireflective film.

3. The assembly of claim 1, wherein the film comprises a transparent thermoplastic material.

4. The assembly of claim 1, wherein the film comprises poly methyl methacrylate (PMMA).

5. The assembly of claim 1, wherein individual microdots of the plurality of microdots have a generally semi-spherical shape.

6. The assembly of claim 1, wherein individual microdots of the plurality of microdots have a height from between about 0.1 mm to 0.4 mm.

7. The assembly of claim 1, wherein individual microdots of the plurality of microdots are arranged to have a uniform spacing therebetween.

8. An assembly comprising:
a film;
a plurality of microdots formed on film; and
a layer of protective glass affixed to the film, the assembly being dimensioned to be utilized in a display and non-optically bonded to a display stack up of the display.

9. The assembly of claim 8, wherein individual microdots of the plurality of microdots have a shape other than semi-spherical.

10. The assembly of claim 8, wherein the layer of protective glass has a thickness from between about 0.7 mm to 0.9 mm.

11. The assembly of claim 10, wherein the film comprises a clear, antireflective film.

12. The assembly of claim 10, wherein the film comprises a transparent thermoplastic material.

13. The assembly of claim 10, wherein the film comprises poly methyl methacrylate (PMMA).

14. The assembly of claim 10, wherein individual microdots of the plurality of microdots have a generally semi-spherical shape.

15. The assembly of claim 10, wherein individual microdots of the plurality of microdots have a height from between about 0.1 mm to 0.4 mm.

16. The assembly of claim 8, wherein the microdots have a reflective index that is the same as a reflective index of the layer of protective glass.

17. A display comprising:
a housing;
an assembly mounted within the housing and comprising:
a film;
a plurality of microdots formed on the film; and
a layer of protective glass affixed to the film;
a display stack up comprising:
one or more panels, the assembly being non-optically bonded to the display stack up;
a light guide plate adjacent the one or more panels; and
a light source adjacent the light guide plate.

18. The display of claim 17, wherein the one or more panels comprise:
an LCD panel comprising at least a liquid crystal display color filter (LCD CF); and
a liquid crystal display thin-film transistor array (LCD TFT).

19. The display of claim 17, wherein the one or more panels comprise:
an LCD panel comprising at least a liquid crystal display color filter (LCD CF); and
a liquid crystal display thin-film transistor array (LCD TFT),
wherein the layer of protective glass has a thickness from between about 0.7 mm to 0.9 mm.

20. The display of claim 17, wherein the one or more panels comprise:
an LCD panel comprising at least a liquid crystal display color filter (LCD CF); and
a liquid crystal display thin-film transistor array (LCD TFT),
wherein the film comprises poly methyl methacrylate (PMMA) and wherein individual microdots of the plurality of microdots have a height from between about 0.1 mm to 0.4 mm.
